(19) United States
(12) Patent Application Publication
(10) Pub. No.: US 2008/0103918 A1
(43) Pub. Date: May 1, 2008

(54) Method and system for making a re-order of pre-designated items by establishing a session and by sending a single short message using short message service via a cellular communications network

(76) Inventors: John T. Burnette, Tallahassee, FL (US); Scott S. Arkin, Tallahassee, FL (US); Aaron L. Beverly, Portland, OR (US); John B. Thomas, Tallahassee, FL (US); Richard A. Wise, Tallahassee, FL (US)

Correspondence Address: Stephen C. Glazier;Kirkpatrick & Lockhart Preston Gates & Ellis LLP, 1601 K Street, N.W., Washington, DC, 20006-1600, US

(21) Appl. No.: 11/811,562

(22) Filed: Jun. 11, 2007

Related U.S. Application Data
(60) Provisional application No. 60/813,408, filed on Jun. 14, 2006.

(51) Int. Cl. G06Q 30/00

(52) U.S. Cl. 705/26

(57) ABSTRACT

A method and process for providing a single text message to re-order pre-designated items of goods or services using a cellular phone over a cellular communications network, and a method and process for receiving a single text message to accept a re-order, process the re-order, initiate shipment, or delivery and payment. Thus a considerable more versatile, simple, and convenient re-order process is provided for a cell phone user's re-ordering goods or services via SMS text message from a receiver system accepting SMS text messages over a cellular communications network.

### CROSS-REFERENCE TO RELATED APPLICATIONS

This application claims the benefits of PPA Ser. Nr. 60/813,408, filed 2006, Jun. 14 by the present inventors.

### FEDERALLY SPONSORED RESEARCH

Not Applicable.

### SEQUENCE LISTING OR PROGRAM

Not Applicable.

### BACKGROUND OF THE INVENTION—FIELD OF INVENTION

This invention relates to making a re-order of pre-designated items by establishing a session and by single short message using short message service via a cellular communication network.

### BACKGROUND OF THE INVENTION—PRIOR ART

This invention relates to the use of text messages over cell phones and Personal Digital Assistants (PDAs), specifically to a method and system that allows users to place text message re-orders (repeat orders) for pre-designated items and receive confirmations via text messages of the request for the pre-designated items re-ordered using the standard text messaging capabilities of cell phones and PDAs with the individual user identified in the process by the user's unique cell phone number and the optional use of a preset password, and the receiver of the text message, from which goods or services are being re-ordered and confirmed, being identified by either a standard short code (a randomly assigned five(5) or six(6) digit code) or a vanity code (a chosen five(5) or six(6) digit code) leased from the Common Short Code Administration (CSCA)). The method and system operates over current cellular communication networks based on either Code Division Multiple Access (CDMA) or Global Systems Mobile (GSM) standards.

U.S. Pat. No. 5,960,411 to Amazon (1999) addresses placing a new purchase order from a catalog over the Internet using a Web browser. The order is placed by the user at a client system and received by a server system. The server system receives user's information including identification of the user, payment and shipping information from the client system. This patent is not relevant to our invention because our invention does not use the Internet as the communications network but rather uses cellular phone networks. Further, our invention of the process and method for re-ordering pre-designated items does not use client systems, Web browsers, or server systems but rather uses an SMS text message for re-ordering and confirming the purchase.

In conclusion, insofar as we are aware, no method or system using cellular phone networks for placing, receiving and confirming re-orders for pre-designated items, representing either goods or services has been identified, described or implemented in the manner and in the configurations as outlined in the claims herein.

### SUMMARY

The invention, a method and system using cellular phone networks for single message re-ordering origination and confirmation of pre-designated items, representing both goods and services, allows the user to reduce the number of steps and processes necessary to complete the transaction and does not use the Internet and Web browsers for order origination.

Accordingly, several objects and advantages of the invention are to provide an improved, streamlined, efficient re-ordering process using cell phones and PDAs over cellular communications networks; to provide a means of added convenience and time savings to the user; to provide the simplest combination of steps and processes to ensure user's satisfaction and to provide a more user friendly, mobile method and process for re-ordering pre-designated items. Still further objects and advantages will become apparent from a study of the following description and the accompanying drawings.

### BRIEF DESCRIPTION OF THE DRAWINGS

FIG. 1 is an illustration of the single message re-ordering in one embodiment of the present invention

FIG. 2 is a diagram illustrating an embodiment of the invention

FIG. 3 is a flow diagram of a single message re-order (repeat order)

FIG. 4 is a flow diagram of a routine which processes a re-order message

FIG. 5 is a flow diagram of a routine to track a confirm or return message, sent back to the user and re-send the message, if needed

### DETAILED DESCRIPTION OF THE DRAWINGS

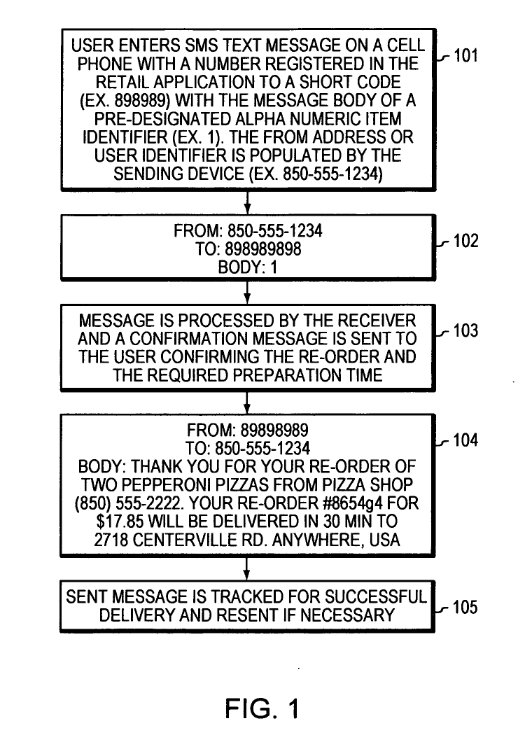

FIG. 1 Illustrates the single message re-order (repeat order) in one embodiment of the present invention. FIG. 1 illustrates the sending of a single message for re-order and the receiving of a single message for confirmation of the re-order. These example messages and description of steps involved contains a description of the user sent message section 101, an example single message re-order (SMS) message as entered into the mobile device or cell phone messaging system section 102, a description of the message processing by the receiving system and the confirmation message sent to the user section 103, an example confirmation SMS message as received by the user section 104, and a description of the step where the message sent to the user is tracked for successful delivery section 105.

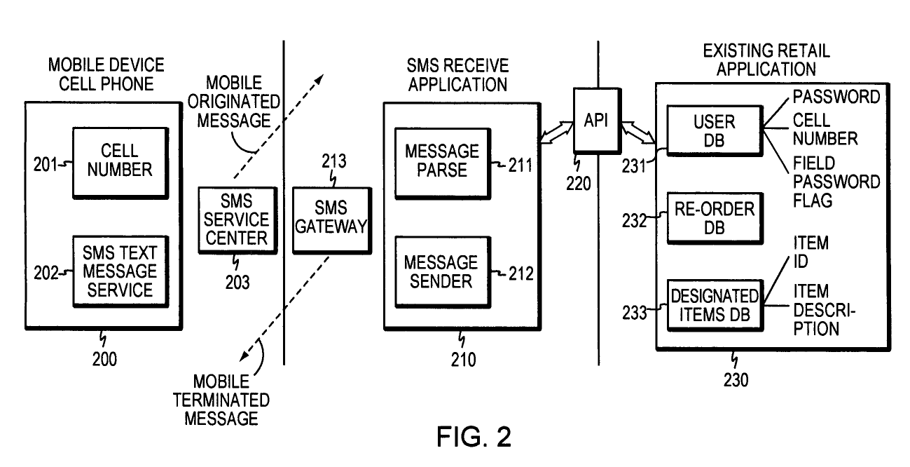

FIG. 2 is a diagram illustrating an embodiment of the present invention. This embodiment supports the single message re-order (repeat order) over a cellular network. The mobile device or cell phone 200 has a cell phone number 201 and operates an SMS text message service 202 which can send Mobile Originated (MO) messages 204 and receive Mobile Terminated Messages (MT) 214 through a short message service center 203. The SMS Receive, Parse and Send operation 210 is made up of a Message Parse System 211 and a Message Send System 212. The Message Parse System 211 receives Mobile Originated messages 204 and separates and defines the data to be sent to the Existing Retail application 230 through the Application Programming Interface (API) 220. The Message Sending System 212 sends Mobile Terminated (MT) messages 214 through an SMS Gateway 213 for the purpose of sending a return or confirmation message to the user. The Application Programming Interface 220 facilitates data to be sent between the SMS Receive, Parse, and Send Application 210 and the Existing Retail Application 230 through a communications network, for the purpose of sending re-orders by the user to the Existing Retail Application 230 and then send confirmation back to the user. The Existing Retail Application 230 can be owned and operated by any entity with data transfer allowed through an API 220. The Existing Retail Application 230 will consist of user data 231, existing order data 232, and pre-designated re-order items/descriptions 233. The User Data 231 will need to include a User Password Field, a Mobile Device/Cell Phone Number Field, and a Password Required for Re-order field.

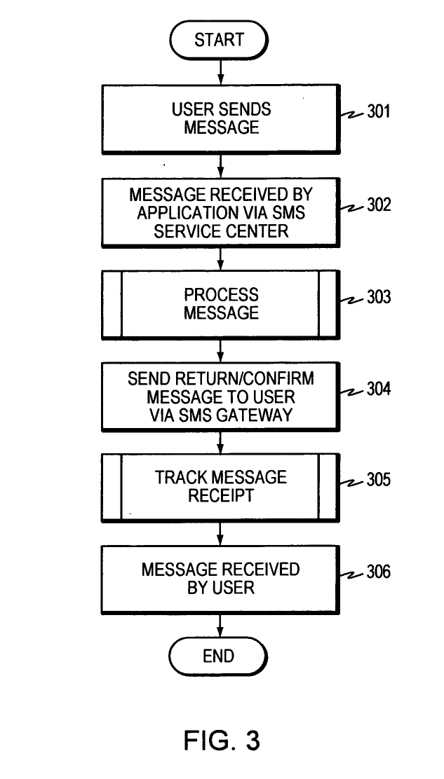

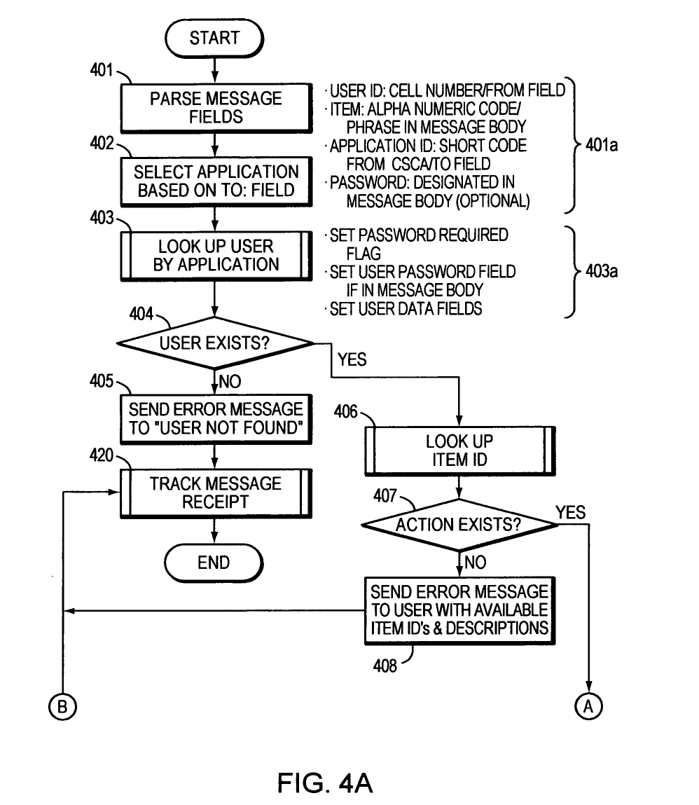

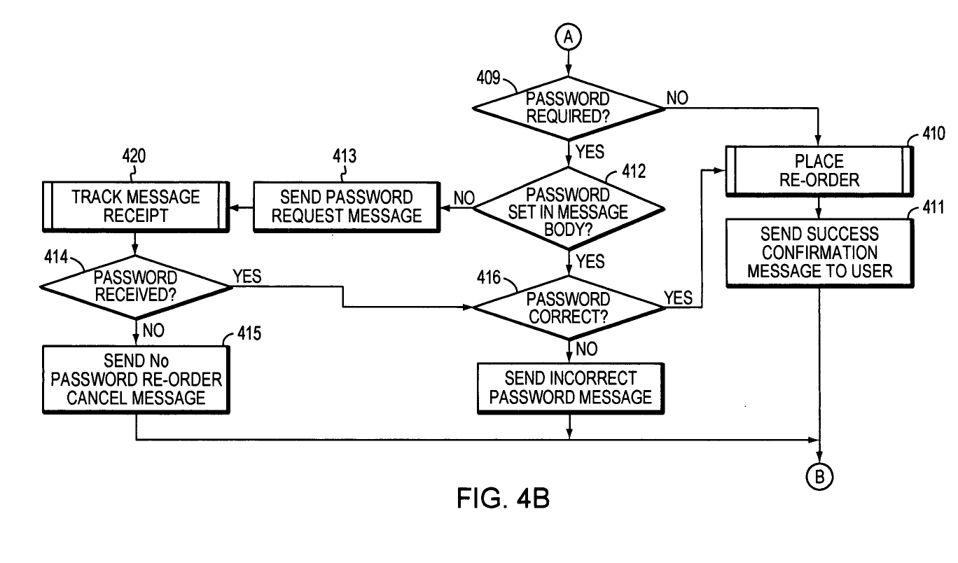

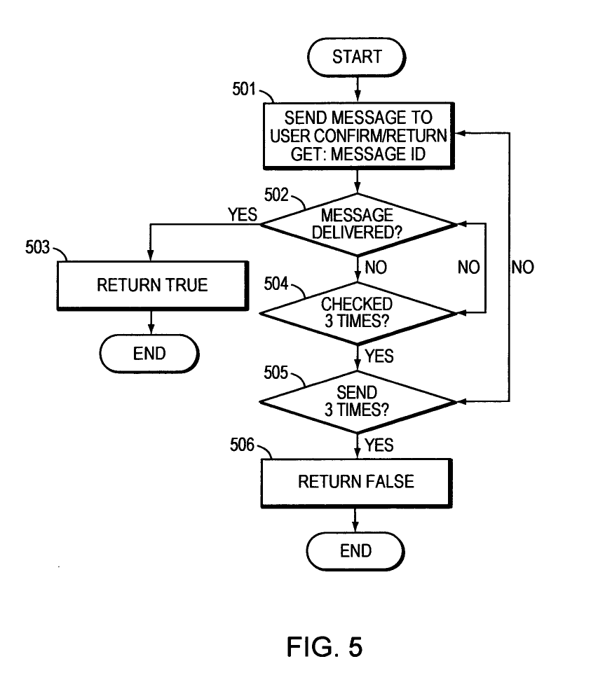

FIG. 3 is a flow diagram of a single message re-order. In step 301 the user sends the single SMS message which initiates a session for re-ordering a pre-designated item(s). In step 302 the message is received by the application via the short message service center and the re-order session is opened. Step 303 is where the message is processed and is further described in FIG. 4. In step 304 return messages are sent to the user via an SMS Gateway. The user's session can be held open should additional messages need to be sent or received for the re-order to be completed. Step 305 is where the message sent by the receiver to the user is tracked for successful delivery. This is further defined in FIG. 5. The message is received in step 306 by the user. If further information, such as a password or re-order verification, is required, the user may reply to this message in the existing re-order session.

FIG. 4 is a flow diagram of a routine which processes a re-order message. The message processing routine starts with parsing the message fields in step 401 to extract the data or message into designated data fields in 401a. The routine then will select the application in step in step 402 based on data parsed from the To field in 401a. Next to the routine will lookup the user in step 403 over the API connection to the existing retail application and set appropriate data fields 403a, if the user exists 404. If the user does not exist a user not found message 405 and the message will be tracked for successful delivery 420. If the user exists the routine proceeds to lookup the item identified in step 406. If the item identifier does not exist the user will be sent a message in step 408 with the message body containing a Re-order Item Not Found error and a list of all available item codes, and descriptions and the message will be tracked for successful delivery in step 420. If the item ID exists in the existing retail application as checked over the API connection in step 407, the routine proceeds to step 409 where the routine determines if a password or any further action is required by the user. If no further action is required to be received by the user, the routine continues to step 410 and places the re-order for the user into the existing retail application. The routine then sends a Success confirmation message to the user in step 411 and tracks the message for successful delivery in step 420. If the user elects to receive a password for re-order confirmation, the routine continues to step 412 to check the parsed data fields in step 403a for a password in the message body. If the password is not in the message body, the routine continues to step 413 and sends a message to the user requesting the user's password and waits for reply in step 414. This message is tracked for successful delivery and resent if necessary. If a password is not received in step 414 before the timeout period expires the routine sends No Password Received message in step 415 and tracks the message for successful delivery in step 420. When a password is received in step 414 or if the password is sent in the message body in step 412, the routine continues to step 416 to check the password against the user account in the existing retail application over the API. If the password checking in step 416 is not correct, the routine continues to step 417 where an Incorrect Password message is sent to the user which is traded for successful delivery in step 420. If the password is correct in step 416, the routine continues to step 410 and places the re-order for the user in the existing retail application. The routine then sends a success confirmation message to the user in step 411 and tracks the message for successful delivery in step 420.

FIG. 5 is a flow diagram of a routine to track a Confirm or Return message sent back to the user within the session initiated by the user and resend the message if needed. This routine starts when the receiver sends a message to the user in step 501 and stores the message ID for tracking. In step 502 the routine checks the SMS Gateway to determine successful message delivery. IF the message has been delivered successfully, the routine continues to step 503 and returns TRUE to the requesting routine. If the message has not been delivered, the routine moves to step 504 where the message delivery (step 502) is checked three times at defined intervals. If after the third check the message has not been delivered, the routine continues to step 505 where the routine checks the number of times the message has been sent. If the message has been sent less than three times the routine returns to step 501 to retry the message send. If the message has been sent three times, the routine continues to step 506 and returns FALSE to the requesting routine.

### OPERATION

The present invention provides a method and system for single message re-ordering of pre-designated items over a cellular network. The single message re-ordering system of the present invention reduces the number of user interactions needed to place the re-order on any existing retail application and eliminates sensitive information sent over the cellular network while minimizing problems from a mobile or cellular device. The user-specific information is in the existing retail application and the user is identified by the cellular number in the From field on the SMS short message. The user can require a password to be sent to the retail application to further confirm identity of the user. When a user wants to place a re-order for a pre-designated item or combinations of pre-designated items, the user sends a SMS short message to a short code assigned to the retail application by the Common Short Code Administrator (CSCA) with the letter(s), number(s), symbol(s) or any combination of letters, numbers, or symbols, which represents the pre-designated item(s) to re-order in the body of the message. The user may also provide the user's password in the message body. The user or receiver may pre-designate items for single message re-ordering by assigning the items a single message ID and single message description. For pre-designated items, the user need only send a single message to re-order the item. The existing retail application then completes the re-order by adding the user specific information to the re-order for the user mapped to the cellular number in the “from” field of this SMS short message. Since the cellular phone number identifies the user specific information already stored in the existing retail application, there is no need for such sensitive information to be transmitted via the cellular network or any other communications medium. A single short message user/receiver re-order system can be implemented in various communications networks including instant message environments, electronic mail environments, local networks, wide area networks and other telecommunications environments.

1-9. (canceled)

10. A method executed by a mobile device of ordering a pre-designated item using a short message system (SMS) text message, comprising:
(a) creating a first SMS text message on a mobile device to order an item addressed to a retail seller, with a message body containing a pre-designated alphanumeric item identifier, and addressed from a sending device identifier number;
(b) transmitting the first message; and
(c) receiving a second SMS text message on the mobile device confirming the order.

11. The method in claim 10 wherein the item is a good or service.

12. The method in claim 10 wherein the item is pizza to be delivered.

13. The method in claim 10, wherein the mobile device is one of a mobile phone, a cellular phone, and a personal digital assistant (PDA).

14. The method in claim 10, further comprising receiving the item.

15. A method executed by a programmable apparatus for processing an order for a pre-determined item using an SMS text message, comprising:
(a) receiving with a programmable apparatus an SMS text message, the SMS text message having a message field;
(b) parsing the message field and extracting data;
(c) identifying the item ordered based on the data, and transmitting the order to a retail application; and
(d) sending an order confirmation message.

16. The method in claim 15, further comprising: selecting the retail application based on the data.

17. The method in claim 15 wherein the item is a good or service.

18. The method in claim 15 wherein the item is pizza to be delivered.

19. The method in claim 15, further comprising completing the order for the item.

20. A programmable apparatus for processing an order for a pre-determined item using an SMS text message, having a message field, the apparatus adapted to execute a process comprising the steps of:
(a) receiving an SMS text message;
(b) parsing the message field and extracting data;
(c) identifying the item ordered based on the data, and transmitting the order to a retail application; and
(d) sending an order confirmation message.

21. The apparatus in claim 20, further comprising: selecting the retail application based on the data.

22. The apparatus in claim 20 wherein the item is a good or service.

23. The apparatus in claim 20 wherein the item is pizza to be delivered.

24. The apparatus in claim 20, further adapted to execute the step of completing the order for the item.
